(19) United States
(12) Patent Application Publication
(10) Pub. No.: US 2022/0358778 A1
(43) Pub. Date: Nov. 10, 2022

(54) SYSTEMS, METHODS, AND APPARATUSES FOR IMAGE-TO-TEXT CONVERSION AND DATA STRUCTURING

(71) Applicant: OLME.US LLC, New York, NY (US)

(72) Inventors: Ariella Azogui, New York, NY (US); Marcus Hoed, New York, NY (US)

(73) Assignee: OLME.US LLC, New York, NY (US)

(21) Appl. No.: 17/736,954

(22) Filed: May 4, 2022

Related U.S. Application Data
(60) Provisional application No. 63/306,476, filed on Feb. 3, 2022.
(60) Provisional application No. 63/184,184, filed on May 4, 2021.

(51) Int. Cl. G06V 30/24

(52) U.S. Cl. CPC G06V 30/24

(57) ABSTRACT

A computer system for image-to-text conversion and data structuring may include one or more processors, one or more computer-readable memories, and one or more computer-readable storage devices, and program instructions stored on at least one of the one or more storage devices for execution by at least one of the one or more processors via at least one of the one or more memories. The stored program instructions may include receiving, a screenshot of a source; storing the screenshot on the one or more computer-readable storage devices; converting the screenshot, via OCR, into at least one string of computer-readable text; building a dataset; or flagging at least one string of computer-readable text, based upon one or more configured parameters. The dataset may include each of the at least one string of computer-readable text, sorted into at least one bucket. The at least one bucket may correspond to a variable type.

### CLAIM OF PRIORITY

This application claims priority from U.S. Provisional Patent Application Nos. 63/184,184, and 63/306,476 filed on May 4, 2021, and Feb. 3, 2022, respectively, the contents of which are incorporated herein by reference.

### FIELD OF THE INVENTION

The present disclosure relates to systems, methods, and apparatuses for image-to-text conversion and data structuring. Specifically, this disclosure relates to systems, methods, and apparatuses for optimizing employee productivity by detecting and structuring captured data.

### INTRODUCTION

Everyday, a vast number of graphics containing valuable information are presented to users over the internet or other computational means. Such data may include information pertaining to an employee's duties or habits. However, frequently the manner in which this information is conveyed makes it difficult for a user, such as an employer, to use the information for business management purposes. For example, the information may be presented to an employer in a manner that is visually acceptable, but also makes textual extraction difficult.

Therefore, it would be desirable to have systems, methods, and apparatuses configured to extract and convert text into a format that may benefit the backend of businesses.

### SUMMARY

In an aspect of the present disclosure, a computer system for image-to-text conversion and data structuring may include one or more processors, one or more computer-readable memories, and one or more computer-readable storage devices, and program instructions stored on at least one of the one or more storage devices for execution by at least one of the one or more processors via at least one of the one or more memories. The stored program instructions may include receiving, a screenshot of a source; storing the screenshot on the one or more computer-readable storage devices; converting the screenshot, via OCR, into at least one string of computer-readable text; building a dataset; or flagging at least one string of computer-readable text, based upon one or more configured parameters. The dataset may include each of the at least one string of computer-readable text, sorted into at least one bucket. The at least one bucket may correspond to a variable type.

In an embodiment, the source is a visual representation of a map charting deliveries. Additionally, the screenshot may include one or more configured segments of the source.

In another embodiment, the one or more configured parameters may be one or more user average values corresponding to the variable type.

In yet another embodiment, the variable type may include at least one of duration of trip, employee check-in time, or employee check-out time.

In a further embodiment, the duration of trip variable type may include one or more strings of computer-readable text containing pick-up time, drop-off time, or trip duration.

In an embodiment, the stored program instructions may further include calculating the trip duration based on the difference between the pick-up time value, and drop-off time value.

In another embodiment, the screenshot may be stored in an image format, the format may include any one of JPEG, GIF, PNG, or PDF. Additionally, the at least one string of computer-readable text may be stored in a text format, the text format may include any one of TXT, CSV, JSON, or XML.

In yet another embodiment, the stored program instructions may further include dividing the dataset into one or more sub-datasets.

In a further embodiment, each sub-dataset may correspond to at least one of employee, team, or project. Additionally, each stored string of computer-readable text within each sub-dataset may correspond to the employee, team, or project of the sub-dataset.

In an aspect of the present disclosure, a method for image-to-text conversion and data structuring may include receiving, a screenshot of a source; storing the screenshot on the one or more computer-readable storage devices; converting the screenshot, via OCR, into at least one string of computer-readable text; building a dataset; or flagging at least one string of computer-readable text, based upon one or more configured parameters. The dataset may include each of the at least one string of computer-readable text, sorted into at least one bucket. The at least one bucket may correspond to a variable type.

In an embodiment, the method may further include calculating the trip duration based on the difference between the pick-up time value, and drop-off time value.

In yet another embodiment, the method may further include dividing the dataset into one or more sub-datasets.

In an aspect of the present disclosure, a computer-readable storage medium having data stored therein representing software executable by a computer, the software may have instructions to receive a screenshot of a source; store the screenshot on the one or more computer-readable storage devices; convert the source, via OCR, into at least one string of computer-readable text; build a dataset; or flag at least one string of computer-readable text, based upon one or more configured parameters. The dataset may include each of the at least one string of computer-readable text, sorted into at least one bucket. The at least one bucket may correspond to a variable type.

### BRIEF DESCRIPTION OF THE DRAWINGS

FIG. 1 illustrates a block diagram of a distributed computer system that can implement one or more aspects of an embodiment of the present disclosure;

FIG. 2 illustrates a block diagram of an electronic device that can implement one or more aspects of an embodiment of the present disclosure;

FIG. 3 illustrates a workflow of an embodiment of the present disclosure.

### DETAILED DESCRIPTION

The detailed description provided herein, along with accompanying figures, illustrates one or more embodiments, but is not intended to describe all possible embodiments. The detailed description provides exemplary systems and methods of technologies, but is not meant to be limiting, and similar or equivalent technologies, systems, and/or methods may be realized according to other examples as well.

Those skilled in the art will realize that storage devices utilized to provide computer-readable and computer-executable instructions and data can be distributed over a network. For example, a remote computer or storage device may store computer-readable and computer-executable instructions in the form of software applications and data. A local computer may access the remote computer or storage device via the network and download part or all of a software application or data and may execute any computer-executable instructions. Alternatively, the local computer may download pieces of the software or data as needed, or process the software in a distributive manner by executing some of the instructions at the local computer and some at remote computers and/or devices.

Those skilled in the art will also realize that, by utilizing conventional techniques, all or portions of the software's computer-executable instructions may be carried out by a dedicated electronic circuit such as a digital signal processor (“DSP”), programmable logic array (“PLA”), discrete circuits, and the like. The term “electronic apparatus” may include computing devices or consumer electronic devices comprising any software, firmware or the like, or electronic devices or circuits comprising no software, firmware or the like.

The term “firmware” as used herein typically includes and refers to executable instructions, code, data, applications, programs, program modules, or the like maintained in an electronic device such as a ROM. The term “software” as used herein typically includes and refers to computer-executable instructions, code, data, applications, programs, program modules, firmware, and the like maintained in or on any form or type of computer-readable media that is configured for storing computer-executable instructions or the like in a manner that may be accessible to a computing device.

The terms “computer-readable medium”, “computer-readable media”, and the like as used herein and in the claims are limited to referring strictly to one or more statutory apparatus, article of manufacture, or the like that is not a signal or carrier wave per se. Thus, computer-readable media, as the term is used herein, is intended to be and must be interpreted as statutory subject matter.

The term “computing device” as used herein and in the claims is limited to referring strictly to one or more statutory apparatus, article of manufacture, or the like that is not a signal or carrier wave per se, such as computing device 101 that encompasses client devices, mobile devices, wearable devices, one or more servers, network services such as an Internet services or corporate network services based on one or more computers, and the like, and/or any combination thereof. Thus, a computing device, as the term is used herein, is also intended to be and must be interpreted as statutory subject matter.

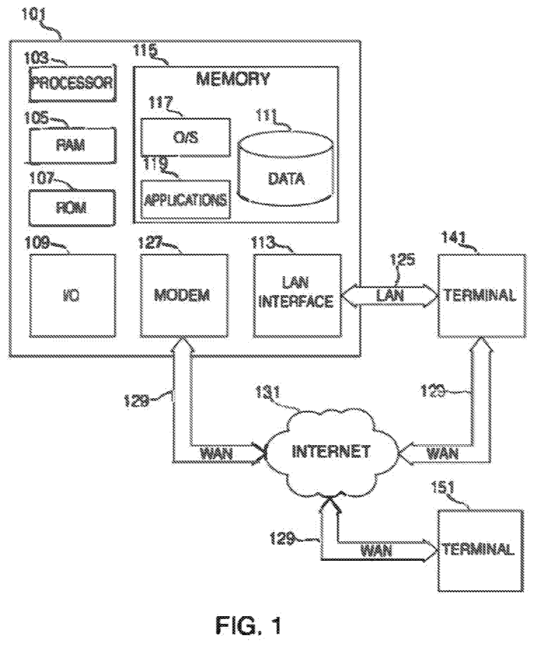

FIG. 1 is an illustrative block diagram of system 100 based on a computer 101. The computer 101 may have a processor 103 for controlling the operation of the device and its associated components, and may include RAM 105, ROM 107, input/output module 109, and a memory 115. The processor 103 will also execute all software running on the computer—e.g., the operating system. Other components commonly used for computers such as EEPROM or Flash memory or any other suitable components may also be part of the computer 101.

The memory 115 may be comprised of any suitable permanent storage technology—e.g., a hard drive. The memory 115 stores software including the operating system 117 any application(s) 119 along with any data 111 needed for the operation of the system 100. Alternatively, some or all of computer executable instructions may be embodied in hardware or firmware (not shown). The computer 101 executes the instructions embodied by the software to perform various functions.

Input/output (“I/O”) module may include connectivity to a microphone, keyboard, touch screen, and/or stylus through which a user of computer 101 may provide input, and may also include one or more speakers for providing audio output and a video display device for providing textual, audiovisual and/or graphical output.

System 100 may be connected to other systems via a LAN interface 113.

System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129, but may also include other networks. When used in a LAN networking environment, computer 101 is connected to LAN 125 through a LAN interface 113 or adapter. When used in a WAN networking environment, computer 101 may include a modem 127 or other means for establishing communications over WAN 129, such as Internet 131.

It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program(s) 119, which may be used by computer 101, may include computer executable instructions for invoking user functionality related to communication, such as email, Short Message Service (SMS), and voice input and speech recognition applications.

Computer 101 and/or terminals 141 or 151 may also be devices including various other components, such as a battery, speaker, and antennas (not shown).

Terminal 151 and/or terminal 141 may be portable devices such as a laptop, cell phone, smartphone, smartwatch, or any other suitable device for storing, transmitting and/or transporting relevant information. Terminals 151 and/or terminal 141 may be other devices. These devices may be identical to system 100 or different. The differences may be related to hardware components and/or software components.

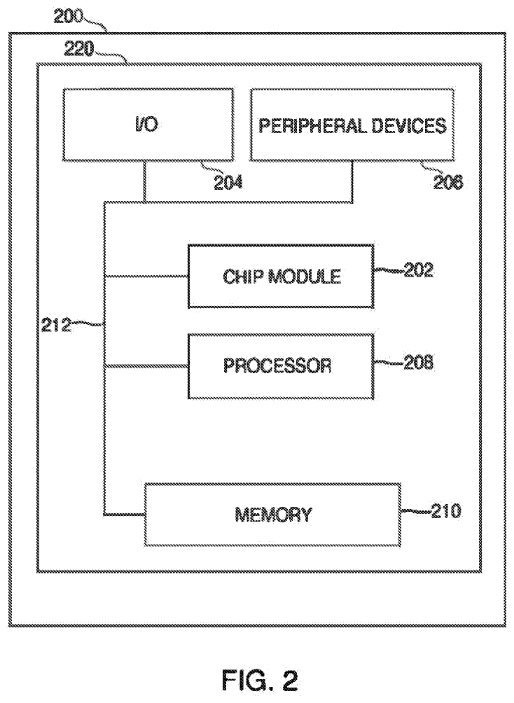

FIG. 2 shows illustrative apparatus 200. Apparatus 200 may be a computing machine. Apparatus 200 may include one or more features of the apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable encoded media or devices; peripheral devices 206, which may include counter timers, real-time timers, power-on reset generators or any other suitable peripheral devices; logical processing device 208, which may test submitted information for validity, scrape relevant information, aggregate user financial data and/or provide an auth-determination score(s) and machine-readable memory 210.

Machine-readable memory 210 may be configured to store in machine-readable data structures: information pertaining to a user, information pertaining to an account holder and the accounts which he may hold, the current time, information pertaining to historical user account activity and/or any other suitable information or data structures.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

Disclosed herein are systems, apparatuses, and methods (the “System”) for image-to-text conversion and data structuring.

The present disclosure may include a user interface module for user management. The user interface module may include at least one digital button. The button may be activated by input via a touch screen, or via a user “clicking” the button via a mouse. In an embodiment, there is an “add user” or “create” button. Activation such button may generate and display one or more add user input fields to the user. The add user input fields may allow a user to enter, via an input method, a first name, last name, email, password, role, or status of a user, for purposes of creating a user account. Other information may include date of birth, phone number, address, or any other suitable information.

The user interface may include a “read” button. Activating the read button may display a table containing information relating to registered users. Such information may include any information entered into the add user input fields for each registered user. Additional information may include access status, user creation date. The table may also include a plurality of options displayed as buttons. These options may include “unlock/lock,” “delete,” “edit,” or any other suitable option.

In an embodiment, the user interface includes an “update” button. Activating the update button may allow a user to edit the information originally entered into the add user input fields for a specific user.

The user interface may include a “delete” button. Activating the delete button may a pop-up window to appear on the display. The pop-up window may contain a confirmation message asking the user to confirm whether they wish to delete a specific user account. A user may then interact with a confirm button displayed in the pop-up window to delete a specific user account. Alternatively, the use may interact with a cancel button displayed in the pop-up window to cancel the “delete” action.

An aspect of the present disclosure may include a role management module. The role management module may include at least one role. A role may include a set of privileges granted to a user. The role management module may include a plurality of functions which are discussed in further detail below.

The role management module may include a “create” function. The create function may allow a user to define and create a new role. In an embodiment, the user defines parameters including role name, role description, and role permissions.

The role management module may include a “read” function. The read function may allow a user to retrieve and display a table. The table may contain a list of existing roles and related information. Such related information may include role name, role description, role creation date, and various actions which may be performed in connection with the role.

In an embodiment, the role management module includes an “update” function. The update function may allow a user to edit existing roles. The update function may allow a user to edit a plurality of role parameters including role name, role description, or role permissions.

The role management module may include a “delete” function. The delete function may be activated via a “delete” button displayed on a user interface of the role management system. Activating the delete button may a pop-up window to appear on the display. The pop-up window may contain a confirmation message asking the user to confirm whether they wish to delete a specific role. A user may then interact with a confirm button displayed in the pop-up window to delete a specific role. Alternatively, the use may interact with a cancel button displayed in the pop-up window to cancel the “delete” action.

In an embodiment, the role management system includes a “pagination” function. The pagination function may allow a user to customize the number of roles displayed in the read function. In an embodiment, a drop-down menu may be displayed on the user interface of the role management system when the read function is active. The drop-down menu may contain a plurality of numbers corresponding to the number of roles the user wishes to be displayed. For example, the drop-down menu may include the numbers 10, 25, 50, 75, or 100. The user may select a number within the drop-down menu to cause the user interface to display the corresponding number of roles. As a non-limiting example, the user may select “50” to cause the user interface to display 50 roles.

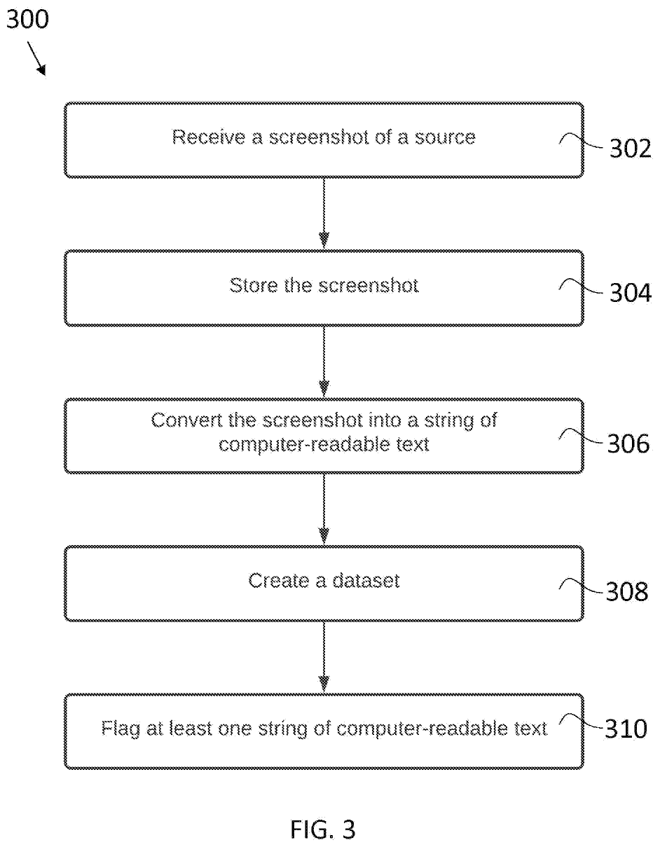

FIG. 3 shows the workflow 300 of an embodiment of the present disclosure. In an embodiment, the system is presented with a source, such as a webpage or other visual representation of data. In an embodiment, the source is the user interface module for user management. In another embodiment, the source is a user interface of the role management module. In yet another embodiment, the source is an interface generated and displayed by a third-party program or software element. The source may include any number of variables and potential values. As a non-limiting example, the source may be a visual representation of a map charting deliveries. In such a non-limiting example, the source may include information regarding, drop-off time, duration of a delivery person's route, etc. In another embodiment, the source may be a visual representation of a business management system (for example, including clock-in and clock-out times for particular employees). However, the source may include any suitable visual representation of information.

At step 302, the system may capture a screenshot of the source. In such an embodiment, the screenshot may be stored in a format, including JPEG, GIF, PNG, or PDF. However, any suitable format may be used. At step 304, the screenshot(s) may be stored on the memory 210. Alternatively, the screenshot(s) may be stored, temporarily or permanently, in any suitable computer-readable storage device, locally or via a server.

At step 306, in an embodiment, the screenshot is converted to text via Optical Character Recognition (“OCR”). For example, the visual representation of an employee's clock in time may be converted to the string of text: “Clock-in time: 10:01 AM.” However, the visual representation or original image may be converted into any usable format of text string. The screenshot may be converted segmenting parts of the image or text and isolating features of each segment. From there, the OCR system may recognize the features against corresponding features stored in a database. Once a match is found, the OCR system may assign the screenshot segment a value, such as a letter or number.

In an embodiment, the source may include unwanted segments of data. For example, the source may include advertising graphics or otherwise superfluous information. In an embodiment, the image may be optimized. In such an embodiment, the screenshot may be configured to capture only the necessary segments of the source. For example, if a web portal includes various information pages for each employee, with each page having the same company logo occupying the top third of the page, the screenshot may be configured to capture only the bottom two thirds of the page. The necessary segments of the source may be manually configured, but then automatically applied to future captures. It is anticipated that the initial configuration may be configured automatically via a machine learning algorithm. For example, the machine learning algorithm may automatically detect sensitive information, and accordingly exclude that are from screenshot captures. In another embodiment, the page may include an image of a map, which may be removed during optimization by tailoring the dimensions of the screenshots.

In an embodiment, the screenshot may be saved on the memory unit 210 of the system and then processed via OCR or a similar process. In another embodiment, the screenshot is not saved, and instead may be directly processed via OCR or a similar process.

A web driver may be used to control a web browser, which may navigate in a web environment and open each page that contains wanted information. The web driver may take a screenshot, that screenshot may then be sent to the backend to be “processed” and “optimized” for OCR. Then, OCR may be used to extract text that may be processed to get the needed data.

In another embodiment, a single page may be captured via multiple screenshots. For example, the portion of the page relating to check-in time may be captured and the portion of the page relating to a package's content may be captured. In such an example, the single page may be captured in various correlated segments.

In an embodiment, the screenshot or screenshots may be parsed together to form a new image. The new image may be stored on the memory unit 210.

In an embodiment, the screenshot(s) and/or newly formed image(s) are imported to the image-to-text converter (for example, OCR). The image-to-text converter may convert the image into any computer-readable text format (for example, TXT, CSV, JSON, XML, etc.). The image-to-text converter may be a third-party program or may be a program stored on the memory 210 and configured to run via the processor 208.

At step 308, in an embodiment, the converted text may be further separated in order to build a dataset. At this stage, in an embodiment, the converted text may be sorted to correlate portions of the converted text to its significance from the original image. This may be viewed as a structuring of unstructured data. In an embodiment, the system may sort or divide the computer-readable text into a number of buckets. Each bucket may correlate to a variable from the source. For example, a system may include a bucket for check-in time, which collects the check-in time values as extracted from the computer-readable text.

In an embodiment, the system may extract data from the computer-readable text in various manners. In one embodiment, the system may be seeded with various text strings associated with one or more variables. For example, the system may be configured to correlate the text string “employee_check_in_time” with the variable for an employee's check-in time. In such an embodiment, the system may further be configured to identify text appearing immediately after (or any other relative position) as the variable's value. For example, given the following portion of text, “employee_check_in_time_10:01_AM,” the system may correlate “employee_check_in_time” as the employee check in variable and “10:01_AM” as the employee check in value. The system may be able to detect errors in certain fields. For example, the following portion of text, “employee_check_in_time_25:90_AM,” may trigger an error to be displayed to a user as it is an invalid time. In an embodiment value ranges are set which trigger an error in the event that the text string contains data outside of the set range. This process may be repeated for each set of variables and values, creating a complete dataset.

The complete dataset may be divided into sub-datasets, which may be created for each entity (for example, each employee, a particular team, or a certain project). In an embodiment, the system is configured to utilize the complete dataset and/or sub-datasets to convey information to an employer or other system administrator. In an embodiment, the system is configured to present the complete dataset and/or sub-dataset to a secondary system (for example, a preexisting employer portal or other dedicated software).

In an embodiment, the system is configured to run calculations or otherwise draw conclusions from the dataset. For example, the system may be configured to measure the distance or displacement between pickup position and drop-off position. In another embodiment, the system may be configured to measure the duration of a trip by determining the difference between a pickup time and drop-off time.

In an embodiment, the dataset may be structured such that it may be utilized by artificial intelligence or machine learning (for example, to determine likely characteristics of certain employees, routes, delivered items, etc.). In an embodiment, certain variables may be cross-referenced to determine certain characteristics. For example, duration of trips, an employee's check-in time, and checkout time, may be utilized to determine the productivity of a certain employee. In such an example, employee's having durations of trips closer in temporal length to their total work time may be viewed as more productive workers. At step 310, the system may flag strings of computer-readable text which indicate variables which are outside an accepted range. In an embodiment, this accepted range may be determined against the average of such variables of other users/employees. Where such variables fall below the accepted range, that user may be reported to an administrator for evaluation.

In an embodiment, the system may operate as software. The software may be coded in Javascript or any other comparable language. In an alternate embodiment, data may be scrubbed from the source via HTML, scraping or otherwise downloaded from the source code. In an embodiment, a web driver may be utilized to control a web browser (that may navigate in a third-party webpage and open each page that contains wanted information) along with an extension that may pull the current page's HTML code and send it to the backend so it may be extracted for data.

Finally, while certain novel features of the present disclosure have been shown and described, it will be understood that various omissions, substitutions and changes in the forms and details of the device illustrated and in its operation can be made by those skilled in the art without departing from the spirit of the disclosure.

What is claimed is:

1. A computer system for image-to-text conversion and data structuring comprising one or more processors, one or more computer-readable memories, and one or more computer-readable storage devices, and program instructions stored on at least one of the one or more computer-readable storage devices for execution by at least one of the one or more processors via at least one of the one or more computer-readable memories, the stored program instructions comprising:
receiving, a screenshot of a source;
storing the screenshot on the one or more computer-readable storage devices;
converting the screenshot, via OCR, into at least one string of computer-readable text;
building a dataset,
the dataset including each of the at least one string of computer-readable text, sorted into at least one bucket,
wherein the at least one bucket corresponds to a variable type; and
flagging at least one string of computer-readable text, based upon one or more configured parameters.

2. The computer system of claim 1, wherein the source is a visual representation of a map charting deliveries, and
wherein the screenshot includes one or more configured segments of the source.

3. The computer system of claim 1, wherein the one or more configured parameters are one or more user average values corresponding to the variable type.

4. The computer system of claim 3, wherein the variable type includes at least one of duration of trip, distance of trip, employee check-in time, or employee check-out time.

5. The computer system of claim 1, wherein the variable type includes at least one of duration of trip, distance of trip, employee check-in time, or employee check-out time.

6. The computer system of claim 5, wherein the duration of trip variable type includes one or more strings of computer-readable text containing pick-up time, drop-off time, or trip duration.

7. The computer system of claim 6, wherein the stored program instructions further include:
calculating the trip duration based on a difference between the pick-up time value, and drop-off time value.

8. The computer system of claim 1, wherein the screenshot is stored in an image format, the format including any one of JPEG, GIF, PNG, or PDF, and
wherein the at least one string of computer-readable text is stored in a text format, the text format including any one of TXT, CSV, JSON, or XML.

9. The computer system of claim 1, wherein the stored program instructions further include:
dividing the dataset into one or more sub-datasets.

10. The computer system of claim 9, wherein each sub-dataset corresponds to at least one of employee, team, or project, and
wherein each stored string of computer-readable text within each sub-dataset corresponds to the employee, team, or project of the sub-dataset.

11. A method for image-to-text conversion and data structuring, the method including:
receiving, a screenshot of a source;
storing the screenshot on one or more computer-readable storage devices;
converting the screenshot, via OCR, into at least one string of computer-readable text;
building a dataset,
the dataset including each of the at least one string of computer-readable text, sorted into at least one bucket,
wherein the at least one bucket corresponds to a variable type; and
flagging at least one string of computer-readable text, based upon one or more configured parameters.

12. The method of claim 11, wherein the source is a visual representation of a map charting deliveries, and
wherein the screenshot includes one or more configured segments of the source.

13. The method of claim 11, wherein the one or more configured parameters are one or more user average values corresponding to the variable type.

14. The method of claim 13, wherein the variable type includes at least one of duration of trip, employee check-in time, or employee check-out time.

15. The method of claim 11, wherein the variable type includes at least one of duration of trip, distance of trip, employee check-in time, or employee check-out time.

16. The method of claim 15, wherein the duration of trip variable type includes one or more strings of computer-readable text containing pick-up time, drop-off time, or trip duration.

17. The method of claim 16, further including:
calculating the trip duration based on a difference between the pick-up time value, and drop-off time value.

18. The method of claim 11, further including:
dividing the dataset into one or more sub-datasets.

19. The method of claim 18, wherein each sub-dataset corresponds to at least one of employee, team, or project, and
wherein each stored string of computer-readable text within each sub-dataset corresponds to the employee, team, or project of the sub-dataset.

20. A computer-readable storage medium having data stored therein representing software executable by a computer, the software having instructions to:
receive, a screenshot of a source;
store the screenshot on one or more computer-readable storage devices;
convert the screenshot, via OCR, into at least one string of computer-readable text;
build a dataset,
the dataset including each of the at least one string of computer-readable text, sorted into at least one bucket,
wherein the at least one bucket corresponds to a variable type; and
flag at least one string of computer-readable text, based upon one or more configured parameters.
